(19) United States
(12) Patent Application Publication
(10) Pub. No.: US 2012/0047271 A1
(43) Pub. Date: Feb. 23, 2012

(54) NETWORK ADDRESS TRANSLATION DEVICE AND METHOD OF PASSING DATA PACKETS THROUGH THE NETWORK ADDRESS TRANSLATION DEVICE

(75) Inventors: YAN-RUNG HUANG, Tu-Cheng (TW); YAO-WEN CHANG, Tu-Cheng (TW)

(73) Assignee: HON HAI PRECISION INDUSTRY CO., LTD., Tu-Cheng (TW)

(21) Appl. No.: 12/894,156

(22) Filed: Sep. 30, 2010

(30) Foreign Application Priority Data
Aug. 20, 2010 (CN) 201010258936.6

(51) Int. Cl. G06F 15/16

(52) U.S. Cl. 709/227; 709/245

(57) ABSTRACT

A network address translation (NAT) device requests a network server to transmit an invitation packet sent by a first client to a second client, receives a reply invitation packet transmitted by the network server, and passes the reply invitation packet to the first client. The NAT device requests the network server to transmit a session packet sent by the first client to the second client, and receives a reply session packet directly sent from the second client. The NAT device passes the reply session packet through the NAT device to reach the first client on condition that a destination port in the reply session packet is the same as a source port in the session packet, so as to establish communication between the first client and the second client.

### BACKGROUND

1. Technical Field

Embodiments of the present disclosure relates to communication devices and methods, and more particularly, to a network address translation device (NAT) and a method of passing data packets through the NAT.

2. Description of Related Art

Network address translation device (NAT) devices are usually firewalls or routers, and are placed between private networks and the Internet. When computers on a private network want to communicate on the Internet, the NAT device modifies data packets sent by the computers on a private network to have an Internet protocol (IP) address on the Internet. In this way, hundreds or thousands of computers on the private network can share just one IP address on the Internet. For example, there may be 250 host computers on the 192.168.1.x network and one firewall providing NAT services on the IP address 216.17.138.210. Any time one computer communicates across the Internet, the NAT firewall changes the IP address of the data packets sent by the computer to 216.17.138.210.

To prevent attacks from other private networks, the NAT device may prevent data packets from being directly sent from the other private networks through the NAT device. However, as a result normal communication between the private networks cannot be established. Therefore, a network server is often needed as a media for establishing normal communication between the private networks. Due to that all data packets needed to be transmitted by the network server between computers placed in different private networks, delay cannot be avoided in the normal communication.

### BRIEF DESCRIPTION OF THE DRAWINGS

FIG. 1 is a schematic view of one embodiment of an application environment of a network address translation (NAT) device.

FIG. 2 is a block diagram of one embodiment of the NAT device in FIG. 1.

FIG. 3 is a flowchart of one embodiment of a method for passing data packets through the NAT device in FIG. 1.

FIG. 4 is a process chart for passing data packets trough the NAT device in FIG. 1.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the following method refers to a collection of software instructions, written in a programming language, such as C, or Assembly. One or more software instructions may be embedded in firmware, stored in any type of computer-readable medium or other computer storage device, and executed by processors of computing devices.

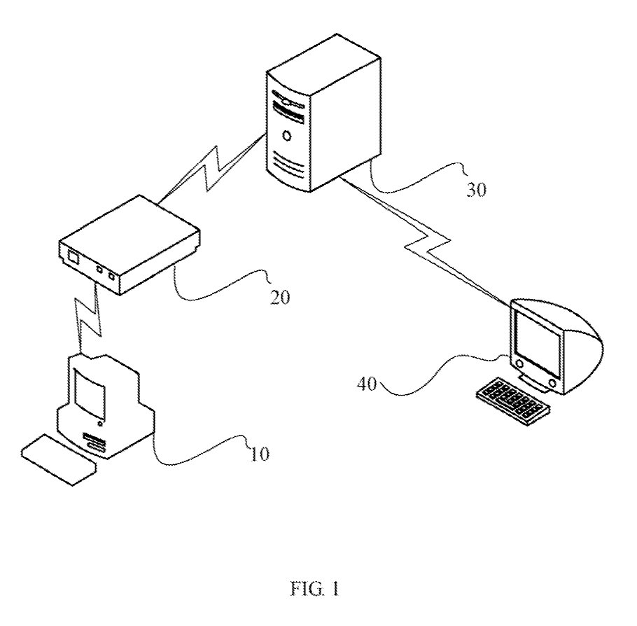

FIG. 1 is a schematic view of one embodiment of an application environment of a network address translation (NAT) device 20. In one embodiment, a first client 10 is connected to the NAT device 20, the NAT device 20 is connected to a network server 30, and the network server 30 is connected to a second client 40. The first client 10 and the second client 40 are positioned in different local area networks (LANs). For example, the first client 10 may be positioned in a first LAN, and the second client may be positioned in a second LAN. Depending on the embodiment, the NAT device 20 may be a router, a firewall, a server, or any other device having a network address translating function.

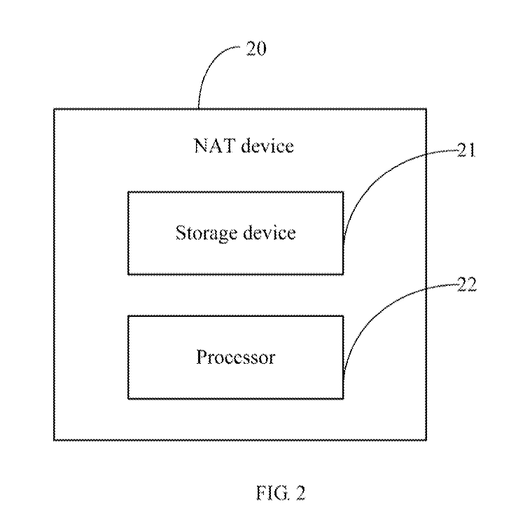

FIG. 2 is a block diagram of one embodiment of the NAT device 20 in FIG. 1. The NAT device 20 includes a storage device 21 and a processor 22. The storage device 21 stores one or more computerized codes, where the processor 22 executes the one or more computerized codes, to provide a function for receiving, analyzing and transmitting data packets between the first client 10 and the second client (detailed description is referred to following paragraphs). Depending on the embodiment, the storage device 21 may be a smart media card, a secure digital card, or a compact flash card.

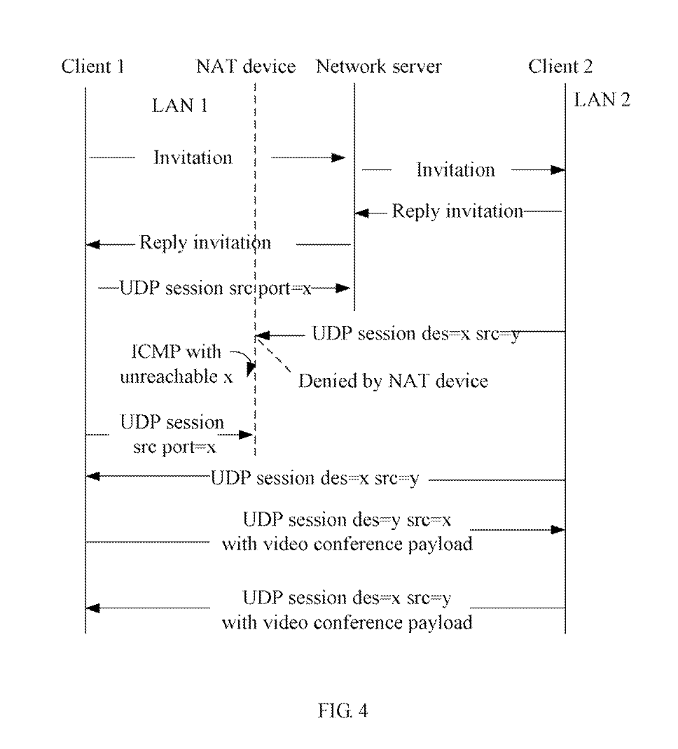

In this embodiment, the NAT device 20 receives data packets sent by the first client 10, and changes a private IP address in the data packets, which is allocated by the first LAN of the first client 10, to a public IP address on the Internet. Then the NAT device 20 requests the network server 30 to transmit the data packets to clients positioned in other LANs, such as the second client 40 in the second LAN. For example, as shown in FIG. 4, the NAT device 20 requests the network server 30 to transmit an invitation packet sent by the first client 10 to the second client 40.

The NAT device 20 further receives data packets sent by the network server 30. For example, as shown in FIG. 4, the NAT device 20 receives a reply invitation packet that is sent by the second client 40 and transmitted by the network server 30, and passes the reply invitation packet to the client 10. The first client 10 may further send a session packet after receiving the reply invitation packet from the network server 30, to establish communication with the second client 40. In this embodiment, as shown in FIG. 4, the session packet is a user datagram protocol (UDP) packet, which includes a source port specifying where the packet comes from and a destination port specifying where the packet is going. The NAT device 20 further requests the network server 30 to transmit the session packet to the second client 40. After receiving the session packet, the second client 40 will generate a reply session packet and directly transmit the reply session packet to the first client 10 to establish the communication. The reply session packet is also a UDP packet.

Furthermore, to prevent attacks from unidentified data packets to the first client 10, the NAT device 20 denies passing data packets that are directly sent by clients in other LANs to the first client 10. Therefore, at first the reply session packet sent by the second client 40 is denied to be passed to the first client 10 by the NAT device 20, and an Internet control message protocol (ICMP) packet is generated by the NAT device 20.

The ICMP packet is used to indicate that the destination port in the reply session packet is unreachable. However, in this embodiment, the ICMP packet will not be immediately sent to the second client 40 by the NAT device 20. After the ICMP packet is generated, the NAT device 20 stores the ICMP packet in the storage device 21 and checks if the destination port in the reply session packet is the same as the source port in the session packet. If the destination port in the reply session packet is different from the source port in the session packet, the NAT device 20 sends the ICMP packet to the second client 40, to inform the second client 40 that the destination port is unreachable. Otherwise, if the destination port in the reply session packet is the same as the source port in the session packet, the NAT device 20 passes the reply session packet through the NAT device 10 to reach the first client 10, to establish the communication between the first client 10 and the second client 20.

After the communication has been established, packets sent by the first client 10 can directly reach the second client 40, and packets sent by the second 40 can directly reach the first client 10 (as shown in FIG. 4). That is, the network server 30 is not needed to transmit these packets between the two clients. As a result, delay in the communication is avoid.

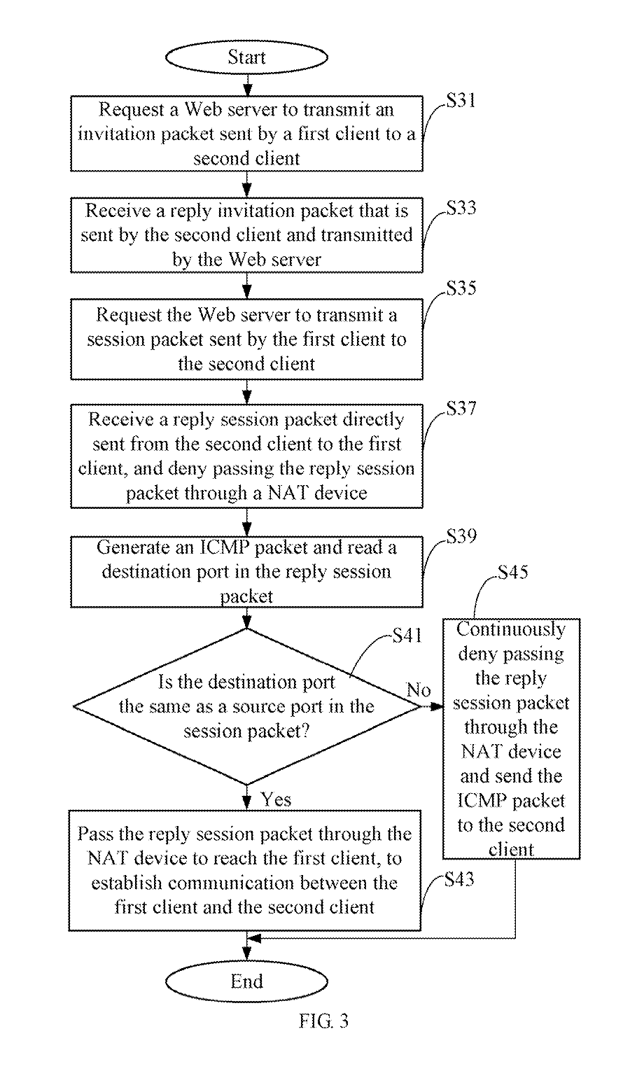

FIG. 3 is a flowchart of one embodiment of a method for passing data packets through the NAT device 20 in FIG. 1. Depending on the embodiment, additional blocks may be added, others removed, and the ordering of the blocks may be changed.

In block S31, the NAT device 20 requests the network server 30 to transmit an invitation packet sent by the first client 10 to the second client 40.

In block S33, the NAT device 20 receives a reply invitation packet that is sent by the second client 40 and transmitted by the network server 30, and passes the reply invitation packet to the first client 10.

In block S35, the NAT device 20 further requests the network server 30 to transmit a session packet sent by the first client 10 to the second client 40. As mentioned above, the session packet is a UDP packet including a source port (e.g., the source port=x) and a destination port.

In block S37, the NAT device 20 receives a reply session packet directly sent from the second client 40 to the first client 10, and denies passing the reply session packet through the NAT device 20. The reply session packet is a UDP packet including a source port and a destination port.

In block S39, the NAT device 20 generates an ICMP packet to indicate that the destination port in the reply session packet is unreachable and stores the ICMP packet in the storage device 21. Then, the NAT device 20 reads the destination port in the reply session packet.

In block S41, the NAT device 20 checks if the destination port in the reply session packet is the same as the source port in the session packet. If the destination port in the reply session packet is the same as the source port in the session packet, the procedure goes to block S43. For example, if the destination port in the reply session packet is also x, block S43 is implemented, the NAT device 20 passes the reply session packet through the NAT device 20 to reach the first client 10, to establish communication between the first client 10 and the second client 40. Otherwise, if the destination port in the reply session packet is different from the source port in the session packet, the procedure goes to block S45, the NAT device 20 continuously denies passing the reply session packet through the NAT device 20, and sends the ICMP packet to the second client 40, to inform the second client 40 that the destination port in the reply session packet is unreachable.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A network address translation (NAT) device, comprising:
at least one processor; and
a storage device storing one or more computerized codes that are executable by the at least on processor, to provide a method for passing data packets trough the NAT device, the method comprising:
(a) requesting a network server to transmit an invitation packet sent by a first client to a second client;
(b) receiving a reply invitation packet that is sent by the second client and transmitted by the network server, and passing the reply invitation packet to the first client;
(c) requesting the network server to transmit a session packet sent by the first client to the second client;
(d) receiving a reply session packet directly sent from the second client, and denying passing the reply session packet through the NAT device; and
(e) checking if a destination port in the reply session packet is the same as a source port in the session packet, if the destination port in the reply session packet is the same as the source port in the session packet, passing the reply session packet through the NAT device to reach the first client, to establish communication between the first client and the second client, if the destination port in the reply session packet is different from the source port in the session packet, continuously denying passing the reply session packet through the NAT device.

2. The NAT device as claimed in claim 1, after block (d) further comprising:
generating an Internet control message protocol (ICMP) packet to indicate that the destination port in the reply session packet is unreachable and storing the ICMP packet in the storage device.

3. The NAT device as claimed in claim 2, wherein block (e) further comprises:
transmitting the ICMP packet to the second client to inform that the destination port in the reply session packet is unreachable, if the destination port in the reply session packet is different from the source port in the session packet.

4. The NAT device as claimed in claim 1, wherein the NAT device is selected from a group consisting of a router, a firewall, and a server.

5. The NAT device as claimed in claim 1, wherein the storage device is selected from the group consisting of a smart media card, a secure digital card, and a compact flash card.

6. A method for passing data packets trough a network address translation (NAT) device, comprising:
(a) requesting a network server to transmit an invitation packet sent by a first client to a second client;
(b) receiving a reply invitation packet that is sent by the second client and transmitted by the network server, and passing the reply invitation packet to the first client;
(c) requesting the network server to transmit a session packet sent by the first client to the second client;
(d) receiving a reply session packet directly sent from the second client, and denying passing the reply session packet through the NAT device; and
(e) checking if a destination port in the reply session packet is the same as a source port in the session packet, if the destination port in the reply session packet is the same as the source port in the session packet, passing the reply session packet through the NAT device to reach the first client, to establish communication between the first client and the second client, if the destination port in the reply session packet is different from the source port in the session packet, continuously denying passing the reply session packet through the NAT device.

7. The method as claimed in claim 6, after block (d) further comprising:
generating an Internet control message protocol (ICMP) packet to indicate that the destination port in the reply session packet is unreachable and storing the ICMP packet in a storage device of the NAT device.

8. The method as claimed in claim 7, wherein block (e) further comprises:
transmitting the ICMP packet to the second client to inform that the destination port in the reply session packet is unreachable, if the destination port in the reply session packet is different from the source port in the session packet.

9. The method as claimed in claim 7, wherein the storage device is selected from the group consisting of a smart media card, a secure digital card, and a compact flash card.

10. The method as claimed in claim 6, wherein the NAT device is selected from a group consisting of a router, a firewall, and a server.
